(19) United States
(12) Patent Application Publication
(10) Pub. No.: US 2011/0049835 A1
(43) Pub. Date: Mar. 3, 2011

(54) CUSTOM DECORATIVE COVERING FOR BICYCLES AND THE LIKE AND METHOD OF MANUFACTURE OF THE COVERING

(76) Inventor: Brad Rafter, West Palm Beach, FL (US)

(21) Appl. No.: 12/550,375

(22) Filed: Aug. 29, 2009

(51) Int. Cl. B62J 99/00; G06F 19/00

(52) U.S. Cl. 280/288.4; 700/159

(57) ABSTRACT

A custom-cut decorative covering, and method of its manufacture, is disclosed, the covering designed to substantially cover at least a frame of a bicycle or similar device without a need for user cutting and/or trimming of the covering. The covering of the invention can be quickly applied and quickly removed and/or replaced, and thoroughly covers portions of the bike so as to make them appear painted. The method for manufacturing the covering includes receiving make and model information and covering-material selection information, converting make and model information into surface-covering information, which information is then sent to a CNC cutting machine, and feeding selected covering material into the CNC machine to be cut in accordance with the surface-covering information. Surface-covering information can be provided by table look-up, CAD/CAM modeling, surface scanning, or hand-measuring of real bicycle parts. In exemplary embodiments, the covering has an adhesive inner surface.

### FIELD OF THE INVENTION

The invention relates generally to vehicle decorations, and more specifically to decorations for bicycles and the like.

### BACKGROUND OF THE INVENTION

Frames and other structural portions of bicycles and the like, such as tandem bicycles, recumbent bicycles, tricycles, and unicycles, are typically covered by chrome and enamel paint, for protection and aesthetic appeal. Such structural portions include handlebars, seats, etc. For many users of these bikes, more customized decoration may be desired.

A number of methods have been used to further decorate portions of bicycles and the like, such as by using stickers, decals, and custom paint. However, these approaches offer some disadvantages. Custom painting a bike can be a time-consuming and expensive project, and the paint can be difficult to remove or modify. Although stickers and/or decals can easily be removed or changed, stickers and decals do not completely cover the entire frame of particular bicycle models, and so they do not typically provide a unified, neat, and professional appearance to the frame and other structures of the bicycle.

And although a nice new paint-job can make the bike look like “new”, the effort and/or expense of such a new paint job makes it difficult to justify frequent new paint jobs, even though one might want to change the look of the bike shortly after the new paint job was completed.

### SUMMARY OF THE INVENTION

The present invention offers advantages over existing prior art by providing a custom-cut decorative covering designed to substantially and neatly cover at least the frame of a bicycle, or other similar device, without a need for cutting or trimming by a user. The covering of the invention can be quickly applied and quickly removed and/or replaced. The covering of the invention so completely covers portions of the bike, those portions can look like they have been painted.

A first general aspect of the invention is a method for manufacturing a custom decorative covering for substantially covering at least a frame of a bicycle or the like. The method includes: receiving make and model information pertaining to at least the frame of the bicycle; receiving covering-material selection information which specifies a selected covering material having an outer decorative surface; converting the make and model information into surface-covering information pertaining to at least the frame of the bicycle; sending the surface-covering information to a computer-numerical-controlled cutting machine; feeding the selected covering material into the computer-numerical-controlled cutting machine; and the computer-numerical-controlled cutting machine cutting the selected covering material in accordance with the surface information, so as to provide the custom decorative covering.

In preferred embodiments, converting includes receiving the make and model information, and using table look-up to provide the surface-covering information. In other preferred embodiments, converting includes receiving a CAD/CAM model associated with the make and model information and deriving the surface-covering information therefrom. In still other preferred embodiments, converting includes using the make and model information to obtain a real bicycle, and scanning the surface of the real bicycle with a laser so as to acquire the surface-covering information. In other preferred embodiments, converting could be accomplished using a tape-measure to acquire various dimensions of the bicycle.

In preferred embodiments, the custom decorative covering is either a single covering designed to be applied to at least the frame of the bicycle, or a plurality of covering pieces cut so as to fit together when applied to at least the frame of the bicycle.

In yet other preferred embodiments, the custom decorative covering includes an adhesive inner surface.

In a preferred embodiment, the covering-material selection information can be selected by either a customer, a retailer, or a manufacturer.

In some preferred embodiments, the method further includes receiving a size pertaining to at least the frame of the bicycle.

In a preferred embodiments, receiving covering-material selection information includes receiving information pertaining to at least one of appearance and texture.

In other preferred embodiments, the make and model information relates to at least one of: the frame of the bicycle; a fork of the bicycle; a chain guard of the bicycle; a wheel guard of the bicycle; and at least one handlebar of the bicycle.

Another general aspect of the invention is a custom decorative covering for substantially covering at least a frame of a bicycle or the like made using the method including the steps of: receiving make and model information pertaining to at least the frame of the bicycle; receiving covering-material selection information which specifies a selected covering material having an outer decorative surface; converting the make and model information into surface-covering information pertaining to at least the frame of the bicycle; sending the surface-covering information to a computer-numerical-controlled cutting machine; feeding the selected covering material into the computer-numerical-controlled cutting machine; and the computer-numerical-controlled cutting machine cutting the selected covering material in accordance with the surface information, so as to provide the custom decorative covering. In preferred embodiments, converting includes receiving the make and model information, and using table look-up to provide the surface-covering information. In other preferred embodiments, converting includes receiving a CAD/CAM model associated with the make and model information and deriving the surface-covering information therefrom. In still other preferred embodiments, converting includes using the make and model information to obtain a real bicycle, and scanning the surface of the real bicycle with a laser so as to acquire the surface-covering information. In other preferred embodiments, converting could be accomplished using a tape-measure to acquire various dimensions of the bicycle.

In preferred embodiments, the custom decorative covering is either a single covering designed to be applied to at least the frame of the bicycle, or a plurality of covering pieces cut so as to fit together when applied to at least the frame of the bicycle.

In yet other preferred embodiments, the custom decorative covering includes an adhesive inner surface.

In a preferred embodiment, the covering-material selection information can be selected by either a customer, a retailer, or a manufacturer.

In some preferred embodiments, the method further includes receiving a size pertaining to at least the frame of the bicycle.

In a preferred embodiments, receiving covering-material selection information includes receiving information pertaining to at least one of appearance and texture.

In other preferred embodiments, the make and model information relates to at least one of: the frame of the bicycle; a fork of the bicycle; a chain guard of the bicycle; a wheel guard of the bicycle; and at least one handlebar of the bicycle.

### BRIEF DESCRIPTION OF THE DRAWINGS

The invention will be more fully understood by reference to the detailed description, in conjunction with the following figures, wherein:

FIG. 1 is an exploded view illustrating a set of custom-cut decorative covering pieces and the manner in which they can be applied to a bicycle frame and other bicycle parts;

FIG. 2 is a flow chart illustrating the method for manufacturing the custom-cut decorative covering of the invention; and

FIG. 3 is an block diagram illustrating the method for manufacturing the custom-cut decorative covering of the invention.

### DETAILED DESCRIPTION OF PREFERRED EMBODIMENTS

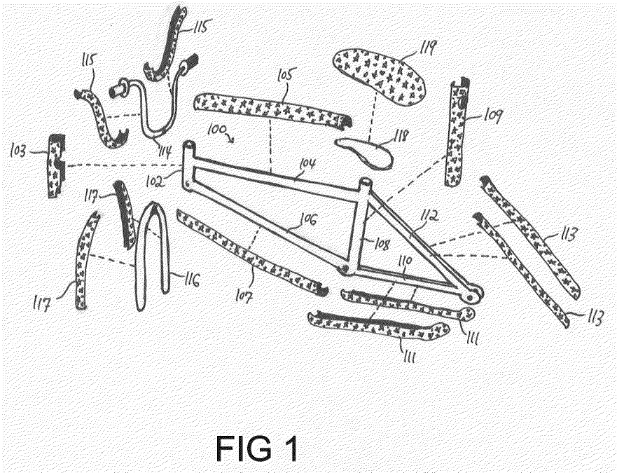

As shown in FIG. 1, an exemplary custom-cut decorative covering is designed to cover at least the frame 100 of a bicycle or the like. In the drawing shown, the covering is a set of covering pieces, each being cut separately and applied to the frame of the bicycle individually. The pieces are designed to fit together with essentially no overlap or space in between them. In other implementations, the custom-cut decorative covering can be a single piece covering piece cut from a single sheet. Although the bicycle frame 100 is used in this example, the custom-cut decorative covering can be cut as a single portion or multiple portions to fit a frame of any recreational cycle vehicle similar to a typical bicycle, such as a tandem bicycle or recumbent bicycle, tricycle, unicycle, and so forth.

Here, the custom-cut decorative covering includes a head tube portion 103 to cover a head tube 102 of the bicycle frame 100, a top tube portion 105 to cover a top tube 104 of the frame 100, and a bottom tube portion 107 to cover a bottom tube 106 of the frame 100. The covering further includes a seat tube portion 109 for a seat tube 108 of the frame, and two seat stay portions 113 as well as two chain stay portions 111, to be applied to the seat stays 112 and the chain stays 110 respectively. The covering can also include handlebar portions 115 to cover the handlebars 114, fork portions 117 to cover the fork 116, and even a seat portion 119 to cover the seat 118, as shown. Although not shown, the covering can also include portions to cover other bicycle parts, such as the chain guard and/or wheel guards.

In exemplary embodiments, the custom-cut decorative covering can include an adhesive inner surface. A user can specify certain preferences concerning the custom-cut decorative covering, such as certain features of the appearance and/or texture of the covering. In the embodiment shown for example, the outer decorative surface of the custom-cut covering includes a pattern of stars. The preferences concerning the covering can be selected by a customer who uses the bicycle, a retailer of the bicycle, and/or a manufacturer of the bicycle, for example.

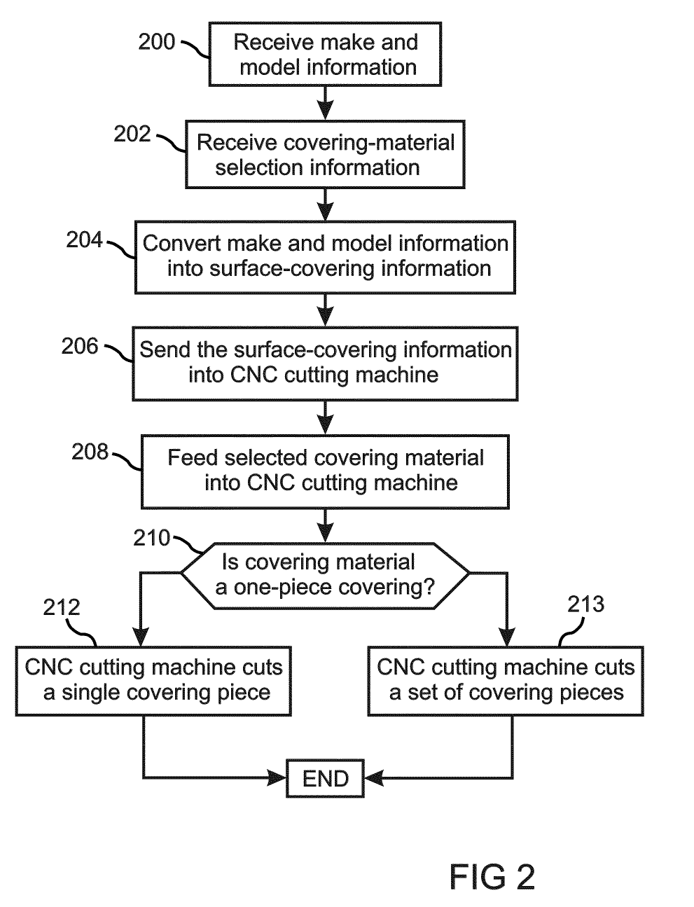

FIG. 2 illustrates the method of method of manufacturing the custom-cut decorative covering. First, make and model information 200, and information related to the selection of the covering material 202, are received. Make and model information is then converted into surface-covering information 204. Surface-covering information is information relating to the surface to be covered by the custom-cut decorative covering. Such information can be obtained using table look-up, by receiving a CAD/CAM model associated with the make and model information and deriving surface-covering information therefrom, and/or by using the make and model information to obtain a real bicycle, and then scanning the surface of the real bicycle, with a laser for example, so as to acquire the surface-covering information.

Next, the surface-covering information is sent to a computer-numerical-controlled (CNC) cutting machine 206. The selected covering material is then fed into the CNC cutting machine 208. If the covering is intended to be a one-piece covering 210, the CNC cutting machine cuts a single piece 212. If the covering is not intended to be a one-piece covering 210, the CNC cutting machine cuts a set of covering pieces 213. The covering pieces from the set will be custom-cut so as to fit together with essentially no overlap, and to completely cover at least the frame of the bicycle. The covering can also cover other parts of the bicycle, such as the fork, the handlebars, the chain guard, and/or the wheel guards. Other parts of the bicycle such as the seat can also be covered with custom-cut decorative covering.

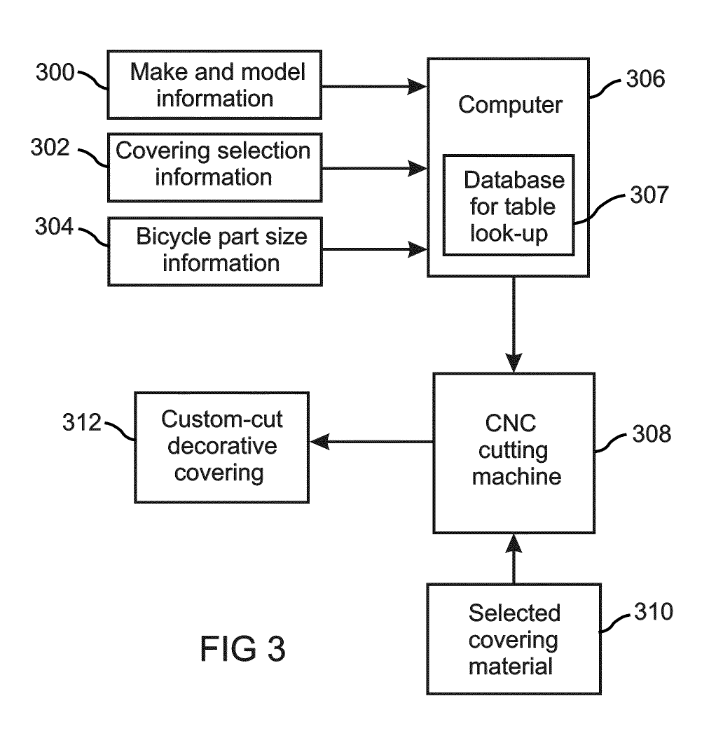

FIG. 3 is an elements diagram illustrating the method of manufacturing the custom-cut decorative covering. Make and model information 300, covering selection information 302, and in this case, information relating to the size of a bicycle part or parts 304, is input into a computer 306. Next, the computer 306 can convert the make and model information 300 into pertinent surface-covering information. In the example shown, this is done by reference to a database 307, using table look-up to provide the surface-covering information. The surface-covering information is then sent to a computer-numerical controlled (CNC) cutting machine 308, which custom cuts the decorative covering in accordance with the surface-covering information. The final result is the custom-cut decorative covering 310, ready to be applied to at least the frame of a bicycle or the like

Other modifications and implementations will occur to those skilled in the art without departing from the spirit and the scope of the invention as claimed. Accordingly, the above description is not intended to limit the invention except as indicated in the following claims.

1. A method for manufacturing a custom decorative covering for substantially covering at least a frame of a bicycle or the like, comprising:
receiving make and model information pertaining to at least the frame of the bicycle;
receiving covering-material selection information which specifies a selected covering material having an outer decorative surface;
converting the make and model information into surface-covering information pertaining to at least the frame of the bicycle;
sending the surface-covering information to a computer-numerical-controlled cutting machine;
feeding the selected covering material into the computer-numerical-controlled cutting machine; and
the computer-numerical-controlled cutting machine cutting the selected covering material in accordance with the surface information, so as to provide the custom decorative covering.

2. The method of claim 1, wherein converting includes receiving the make and model information, and using table look-up to provide the surface-covering information.

3. The method of claim 1, wherein converting includes receiving a CAD/CAM model associated with the make and model information and deriving the surface-covering information therefrom.

4. The method of claim 1, wherein converting includes using the make and model information to obtain a real bicycle, and scanning the surface of the real bicycle with a laser so as to acquire the surface-covering information.

5. The method of claim 1, wherein the custom decorative covering is one of:
a single covering designed to be applied to at least the frame of the bicycle; and
a plurality of covering pieces cut so as to fit together when applied to at least the frame of the bicycle.

6. The method of claim 1, wherein the custom decorative covering includes an adhesive inner surface.

7. The method of claim 1, wherein the covering-material selection information can be selected by one of:
a customer;
a retailer; and
a manufacturer.

8. The method of claim 1, further comprising receiving a size pertaining to at least the frame of the bicycle.

9. The method of claim 1, wherein receiving covering-material selection information includes receiving information pertaining to at least one of appearance and texture.

10. The method of claim 1, wherein the make and model information relates to at least one of:
the frame of the bicycle;
a fork of the bicycle;
a chain guard of the bicycle;
a wheel guard of the bicycle; and
at least one handlebar of the bicycle.

11. A custom decorative covering for substantially covering at least a frame of a bicycle or the like made using the method comprising:
receiving make and model information pertaining to at least the frame of the bicycle;
receiving covering-material selection information which specifies a selected covering material having an outer decorative surface;
converting the make and model information into surface-covering information pertaining to at least the frame of the bicycle;
sending the surface-covering information to a computer-numerical-controlled cutting machine;
feeding the selected covering material into the computer-numerical-controlled cutting machine; and
the computer-numerical-controlled cutting machine cutting the selected covering material in accordance with the surface information, so as to provide the custom decorative covering.

12. The method of claim 11, wherein converting includes receiving the make and model information, and using table look-up to provide the surface-covering information.

13. The method of claim 11, wherein converting includes receiving a CAD/CAM model associated with the make and model information and deriving the surface-covering information therefrom.

14. The method of claim 11, wherein converting includes using the make and model information to obtain a real bicycle, and scanning the surface of the real bicycle with a laser so as to acquire the surface-covering information.

15. The method of claim 11, wherein the custom decorative covering is one of:
a single covering designed to be applied to at least the frame of the bicycle; and
a plurality of covering pieces cut so as to fit together when applied to at least the frame of the bicycle.

16. The method of claim 11, wherein the custom decorative covering includes an adhesive inner surface.

17. The method of claim 11, wherein the covering-material selection information can be selected by one of:
a customer;
a retailer; and
a manufacturer.

18. The method of claim 11, further comprising receiving a size pertaining to at least the frame of the bicycle.

19. The method of claim 11, wherein receiving covering-material selection information includes receiving information pertaining to at least one of appearance and texture.

20. The method of claim 11, wherein the make and model information relates to at least one of:
the frame of the bicycle;
a fork of the bicycle;
a chain guard of the bicycle;
a wheel guard of the bicycle; and
at least one handlebar of the bicycle.
